(19) United States
(12) Patent Application Publication
(10) Pub. No.: US 2010/0156784 A1
(43) Pub. Date: Jun. 24, 2010

(54) DISPLAY APPARATUS AND PROGRAM

(75) Inventor: Atsushi NARUSAWA, Hino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/627,544

(22) Filed: Nov. 30, 2009

(30) Foreign Application Priority Data
Dec. 18, 2008 (JP) 2008-322466

(51) Int. Cl. G06F 3/033; G06T 1/00

(52) U.S. Cl. 345/157; 345/522

(57) ABSTRACT

A display apparatus includes: a display surface that includes a plurality of display elements of which colors are rewritten in accordance with a period of executing a rewriting process; a detection section that detects positions of the plurality of display elements subjected to the rewriting for each predetermined cycle; a rewriting section that rewrites colors of the corresponding display elements by performing the rewriting process on the display elements corresponding to a trace sequentially linking the positions detected by the detection section; a cycle changing section that, when the positions are designated, changes the cycle in which the detection section detects the corresponding positions; and a rewriting period changing section that, when the cycle changing section changes the cycle to be shortened, shortens a period of the rewriting process which is performed on the display elements by the rewriting section.

### BACKGROUND

1. Technical Field

The present invention relates to a technique of suppressing consumption of an electric power required for image display.

2. Related Art

In portable display apparatuses called electronic papers, mobile display apparatuses such as a FDA (Personal. Digital Assistant), and the like, there is a known apparatus that displays an image representing positions, which is designated by a pen tip, when a user makes a tracing on the display surface with a pen. In such a pen drawing, it is preferable to display an image accurately representing the positions designated by the pen. In JP-A-5-324179, when the positions designated by the pen are sampled in a predetermined cycle, a technique of changing the sampling cycle in accordance with a writing speed is disclosed.

When the pen drawing is performed, it is preferable that the image representing the position designated by the pen be displayed as promptly as possible. Further, particularly, in the portable and mobile display apparatuses, it has been urgently required to reduce power consumption.

### SUMMARY

An advantage of some aspects of the invention is to suppress power consumption while promptly displaying an image representing positions successively designated on a display surface.

In order to achieve the advantage, according to a first aspect of the invention, provided is a display apparatus including: a display surface that includes a plurality of display elements of which colors are rewritten in accordance with a period of executing a rewriting process; a detection section that detects positions of the plurality of display elements subjected to the rewriting for each predetermined cycle; a rewriting section that rewrites colors of the corresponding display elements by performing the rewriting process on the display elements corresponding to a trace sequentially linking the positions detected by the detection section; a cycle changing section that, when the positions are designated, changes the cycle in which the detection section detects the corresponding positions; and a rewriting period changing section that, when the cycle changing section changes the cycle to be shortened, shortens a period of the rewriting process which is performed on the display elements by the rewriting section. With such a configuration, it is possible to display promptly an image representing the positions of the designated display elements.

Further, according to a second aspect of the invention, provided is a display apparatus including: a display surface that includes a plurality of display elements of which colors are rewritten in accordance with a period of executing a rewriting process; a detection section that detects positions of the plurality of display elements subjected to the rewriting for each predetermined cycle; a rewriting section that rewrites colors of the corresponding display elements by performing the rewriting process on the display elements corresponding to a trace sequentially linking the positions detected by the detection section; a cycle changing section that, when the positions are designated, changes the cycle in which the detection section detects the corresponding positions; and a rewriting period changing section that, when the cycle changing section changes the cycle to be elongated, elongates a period of the rewriting process which is performed on the display elements by the rewriting section. With such a configuration, it is possible to display promptly the image representing the positions of the designated display elements.

In the aspects of the invention, it is preferable that the cycle changing section should include a direction specifying section that, when the detection section detects the positions, specifies a direction of the trace at the corresponding positions. In addition, it is also preferable that, in a case where the direction of the trace specified by the direction specifying section changes, the cycle changing section should shorten the cycle, in which the detection section detects the positions, when a magnitude of the change of the corresponding direction increases, and should elongate the cycle, in which the detection section detects the positions, when the magnitude of the change of the direction decreases. With such a configuration, it is possible to display accurately the image representing the trace even when the magnitude of change of the direction of the trace is large.

Further, in the aspects of the invention, it is preferable that the cycle changing section should include a displacement specifying section that specifies a displacement of the corresponding positions per unit of time when the positions are successively designated on the display surface. In addition, it is also preferable that the cycle changing section should shorten the cycle, in which the detection section detects the positions, when the displacement specified by the displacement specifying section increases, and should elongate the cycle, in which the detection section detects the positions, when the displacement decreases. With such a configuration, it is possible to display accurately the image representing the trace even when the displacement per unit of time is large at the time of successively designating the positions.

In the aspects of the invention, it is preferable that the rewriting period changing section should change the period of the rewriting process to coincide with the cycle in which the detection section detects the positions. With such a configuration, it is possible to display more promptly the image representing the positions successively designated on the display surface.

Further, according to a third aspect of the invention, provided is a program for causing a computer, which controls a display apparatus having a display surface that includes a plurality of display elements of which colors are rewritten in accordance with a period of executing a rewriting process, to function as: a detection section that detects positions of the plurality of display elements subjected to the rewriting for each predetermined cycle; a rewriting section that rewrites colors of the corresponding display elements by performing the rewriting process on the display elements corresponding to a trace sequentially linking the positions detected by the detection section; a cycle changing section that, when the positions are designated, changes the cycle in which the detection section detects the corresponding positions; and a rewriting period changing section that, when the cycle changing section changes the cycle to be shortened, shortens a period of the rewriting process which is performed on the display elements by the rewriting section. With such a configuration, it is possible to display promptly the image representing the positions of the designated display elements.

Further, according to a fourth aspect of the invention, provided is a program for causing a computer, which controls a display apparatus having a display surface that includes a plurality of display elements of which colors are rewritten in accordance with a period of executing a rewriting process, to function as: a detection section that detects positions of the plurality of display elements subjected to the rewriting for each predetermined cycle; a rewriting section that rewrites colors of the corresponding display elements by performing the rewriting process on the display elements corresponding to a trace sequentially linking the positions detected by the detection section; a cycle changing section that, when the positions are designated, changes the cycle in which the detection section detects the corresponding positions; and a rewriting period changing section that, when the cycle changing section changes the cycle to be elongated, elongates a period of the rewriting process which is performed on the display elements by the rewriting section. With such a configuration, it is possible to display promptly the image representing the positions of the designated display elements.

### BRIEF DESCRIPTION OF THE DRAWINGS

The invention will be described with reference to the accompanying drawings, wherein like numbers reference like elements.

FIG. 1 is an exterior view illustrating a display apparatus.

FIG. 2 is a block diagram illustrating a configuration of the display apparatus.

FIG. 3 is a diagram schematically illustrating a structure of a storable display body.

FIG. 4 is a diagram illustrating an exemplary case where a user makes a drawing on a display surface by using a stylus pen.

FIGS. 5A and 5B are diagrams illustrating relationship between positions on the touch panel and positions of a trace image which are displayed on the display surface.

FIGS. 6A and 6B are diagrams illustrating a relationship between positions on the touch panel and positions of a trace image which are displayed on the display surface.

FIGS. 7A and 7B are diagrams illustrating time-series transitions of the trace images displayed on the display surface at a high sampling rate.

FIG. 8 is a diagram illustrating a time-series transition of the trace image displayed on the display surface at a low sampling rate.

FIGS. 9A and 9B are diagrams illustrating a relationship between positions on the touch panel and positions of a trace image which are displayed on the display surface.

### DESCRIPTION OF EXEMPLARY EMBODIMENTS

Hereinafter, preferred embodiments of the invention will be described with reference to the accompanying drawings.

### A. First Embodiment

### A-1. Configuration of Display Apparatus 10

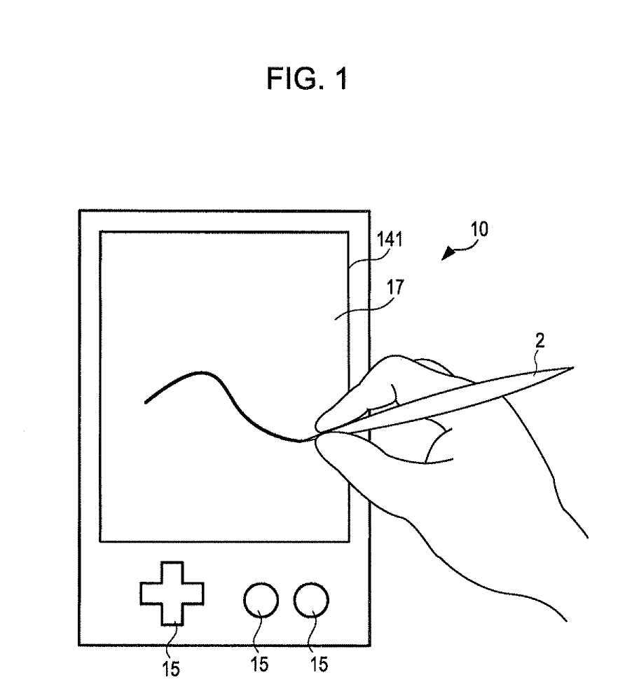

FIG. 1 is an exterior view illustrating the display apparatus 10. The display apparatus 10 is a portable display apparatus which is called an electronic paper and the like. As shown in FIG. 1, on the front side of the display apparatus 10, an operation section 15, a display surface 141, and a touch panel 17 are provided. The display surface 141 has a plurality of display elements, and the display elements are arranged to form thereby a rectangular region. The touch panel 17 is a substantially transparent member formed in a screen shape having a rectangular region of which a size is the same as that of the display surface 141, and is disposed on the front side of the display surface 141. When a user moves a pen tip of a stylus pen 2 along the surface of the touch panel 17, the image representing a position designated by the pen tip is displayed on the display surface 141.

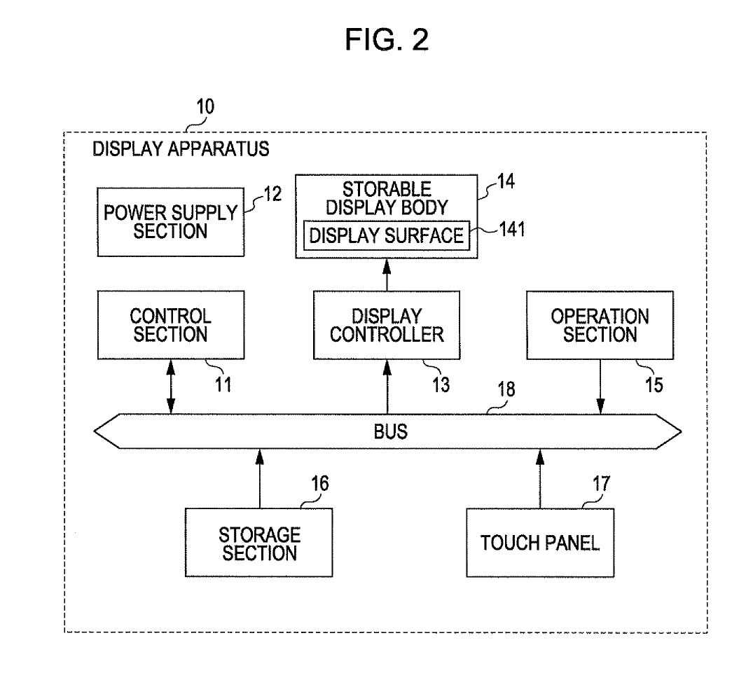

FIG. 2 is a block diagram illustrating a configuration of the display apparatus 10. As shown in the drawing, components provided in the display apparatus 10 are interconnected via a bus 18.

A control section 11 has a CPU (a Central Processing Unit), a memory, a timer, and the like, and controls the respective sections of the display apparatus 10 by allowing the CPU to execute a program stored in the memory. The timer provided in the control section 11 has an oscillating circuit including a crystal oscillator, and measures a time on the basis of the transmission signal output from the oscillating circuit. The power supply section 12 has a rechargeable secondary battery such as Ni—Cd based battery or lithium-ion based battery. The direct current voltage of the secondary battery is supplied as an electric power required for operating the display apparatus 10 to the respective sections of the display apparatus 10 through a power line which is not shown in the drawing.

A storable display body 14 has a reflective display surface 141 formed of, for example, a plurality of electrophoresis elements (the display elements) arranged in a shape having 768 columns in a horizontal direction and 1,024 rows in a vertical direction when a driving voltage is applied, these electrophoresis elements display an image in accordance with the corresponding driving voltage. A display controller 13 applies a driving voltage to the respective electrophoresis elements of the storable display body 14, thereby displaying an image, which is based on image information, on the storable display body 14. As described above, the display controller 13 rewrites colors of the display elements of the display surface 141 by applying the driving voltage and displays the image. Hence, hereinafter, this process is referred to as “rewriting process”.

An operation section 15 has an arrow button, a switch, and the like. The operation section 15 accepts an operation of a user, and supplies an operation signal to the control section 11 in accordance with operation contents thereof. A storage section 16 is a nonvolatile storage section such as an EEPROM (Electrically Erasable and Programmable Read Only Memory) or a flash memory, and stores various data such as image information to be displayed. A touch panel 17 senses contact of an object such as a pen tip of the stylus pen 2 for each predetermined microscopic region. Each microscopic region corresponds to a predetermined number of plural pixels (for example, 1×1 pixel or 3×3 pixels) of the display surface 141. The touch panel 17 outputs a detection signal representing the contact of the object for each microscopic region, and supplies the signal to the control section 11 as a position designated in the display surface 141. To the respective microscopic regions, coordinates representing respective positions thereof are assigned. In the touch panel 17, the respective coordinates are previously stored in the memory of the control section 11. Furthermore, in the touch panel, there are various known types such as an electrostatic capacity type and an electromagnetic induction type, a resistive film type, and any type may be used in the touch panel 17. That is, the control section 11 is an example of a detection section that detects positions successively designated on the display surface 141 by the touch panel 17 for each predetermined cycle.

### A-2. Configuration of Storable Display Body 14

Next, a configuration of the storable display body 14 will be described in detail.

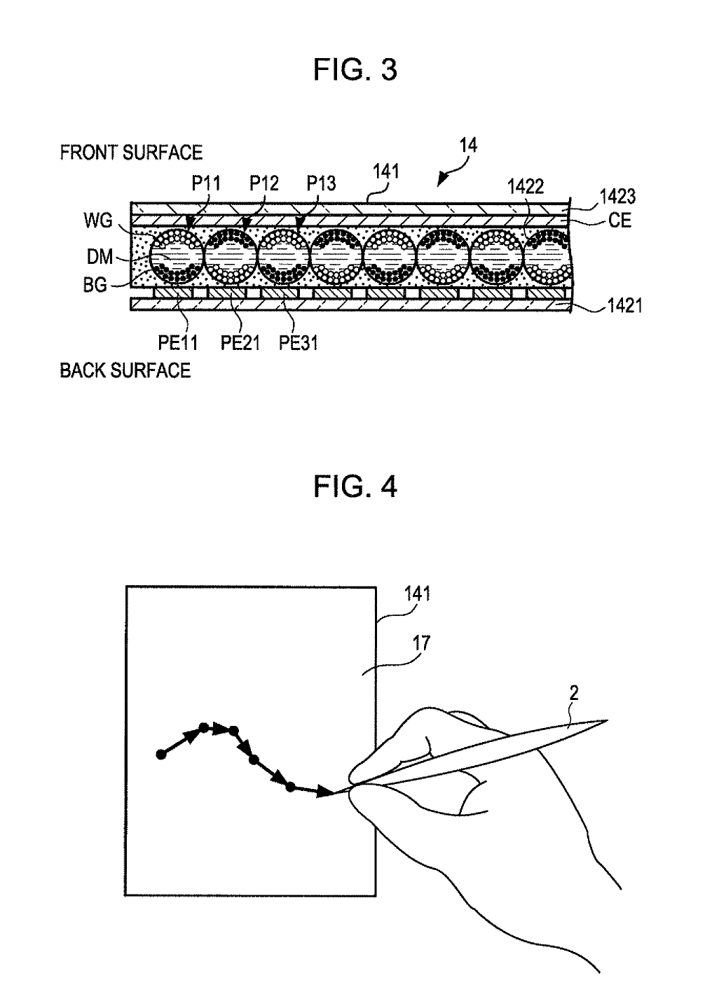

FIG. 3 is a diagram schematically illustrating a structure of a storable display body 14. As shown in the drawing, the storable display body 14 includes a first substrate 1421, electrophoresis elements P11, P12, P13 . . . , a binder 1422, and a second substrate 1423. The first substrate 1421 is a glass substrate, and the pixel electrodes PE11, PE21, PE31 . . . are arranged on the front surface side toward the upper side of the drawing. The second substrate 1423 opposed to the first substrate 1421 is a transparent glass substrate, and a common electrode CE is provided on the back surface side toward the lower side of the drawing. Between the pixel electrodes PE11, PE21, PE31, . . . , and the common electrode CE, an enormous number of electrophoresis elements are arranged and fixed by the binder 1422.

The respective electrophoresis elements are formed as micro capsules. In a polymer film as a capsule wall CW, a liquid (dispersion medium DM) in which negatively (−) charged black pigment grains BG and positively (+) charged white pigment grains WG are distributed are enclosed. In such a manner, in the display surface 141 of the storable display body 14, the plurality of electrophoresis elements are arranged, which enclose the liquid in which the plurality of charged color grains are distributed.

The positions of the black pigment grains BG and the white pigment grains WG are defined by electric field applied from the outside, and are stably maintained by the dispersion medium DM. The electric field is applied by the “rewriting process”. When the electrophoresis element intends to display black, the control section 11 performs the rewriting process so as to give the electric field from the back surface side toward the front surface side (the display surface 141 side) by allowing the pixel electrodes PE to have an electric potential higher than that of the common electrode CE. The action of the electric field causes the positively charged black pigment grains BG to move close to the front surface side in the dispersion medium DM (in liquid) within the capsule wall CW. In addition, the action causes the negatively charged white pigment grains WG to move close to the back surface side in the capsule wall CW. In contrast, when the electrophoresis element intends to display white, the control section 11 performs the rewriting process so as to give the electric field from the front surface side toward the back surface side by allowing the pixel electrodes PE to have an electric potential lower than that of the common electrode CE. The action of the electric field causes the white pigment grains WG to move close to the front surface side in the dispersion medium DM (in liquid). In addition, the action causes the black pigment grains BG to move close to the back surface side.

However, when a color of the electrophoresis element is rewritten by the rewriting process, the electrophoresis element is gradually transited from the color before the rewriting to a color after the rewriting. Accordingly, when the period (hereinafter, referred to as a “rewriting period”) during which the rewriting process is performed is sufficiently long, the movement of the black pigment grains BG and the white pigment grains WG is completed. Hence, each display element displays an intended final color of black or white. In contrast, when the rewriting period is not sufficient, the black pigment grains BG and the white pigment grains WG are moved, and the electrophoresis element is in the middle of the transition between black and white. For example, the transition of color from white to black is completed by performing the rewriting process for 300 ms (milliseconds), but the rewriting process may be performed for 100 ms. In this case, a color, which has a higher brightness than the intended final black, is displayed as an intermediate color therebetween. Further, the positions of the black pigment grains BG and the white pigment grains WG are maintained at the state without application of a voltage. This is called a storage property of display. That is, after an image is displayed, the storable display body 14 is able to maintain the displayed image without application of voltage. Accordingly, when the rewriting process is performed on the electrophoresis element, the rewriting process may be suspended once and started again. In this case, the electrophoresis element displays a color based on the total period of the rewriting process before and after the suspension. As described above, the display surface 141 has the plurality of display elements in each of which a color is rewritten on the basis of the period of the performed rewriting process.

FIG. 4 is a diagram illustrating an exemplary case where a user makes a drawing on the display surface 141 of the display apparatus 10 by using the stylus pen 2.

As shown in FIG. 4, a user moves the pen tip of the stylus pen 2 along the surface of the touch panel 17 disposed on the front side of the display surface 141, thereby successively designating positions on the display surface 141. While the designation is performed, the control section 11 detects the designated positions for each predetermined cycle on the basis of the time measured by the timer. This cycle is, for example, 0.01 seconds. That is, the control section 11 and the touch panel 17 are examples of the detection section that detects the positions successively designated on the display surface 141 for each predetermined cycle. Then, the control section 11 acquires coordinates corresponding to the positions detected on the touch panel 17 from the memory, and rewrites the colors of the display elements of the display surface 141 corresponding to the trace sequentially linking the coordinates by performing the rewriting process. That is, the control section 11 is an example of a rewriting section. In such a manner, the control section 11 displays the image of the trace, which indicates the positions designated by a user, on the display surface 141.

### A-3. Change of Sampling Rate

The control section 11 of the display apparatus 10 changes the sampling rate in accordance with change in a mode of designation when the positions are successively designated on the display surface 141. Here, the mode of designation of position is a direction of the trace. Specifically, the control section 11 specifies a direction of a segment coupling two detected positions (coordinates) as the direction of the trace. The control section 11 increases the sampling rate when the magnitude of change of the direction of the trace increases, and decreases the sampling rate when the magnitude of change of the direction of the trace decreases. In other words, the control section 11 increases the sampling rate as positions formed in a curve shape having a large curvature are designated, and decrease the sampling rate as positions formed in a substantially linear shape having a small curvature are designated. The sampling rate is a value representing a cycle in which the control section 11 detects positions by using the touch panel 17, and the unit thereof is “times/second”, that is, times per second when the control section 11 detects the designated positions on the touch panel 17. As the sampling rate becomes higher, the cycle that the control section 11 detects the positions becomes short, and as the sampling rate becomes lower, the cycle that the control section 11 detects the positions becomes long. Subsequently, the reason for changing the sampling rate will be described.

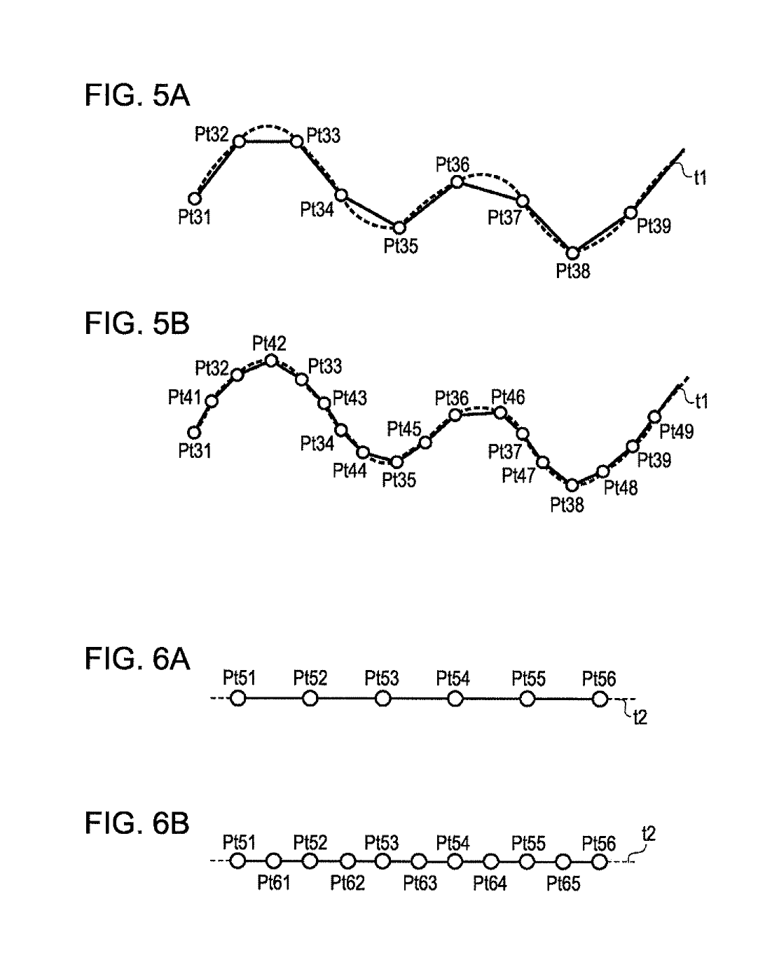

FIGS. 5A, 5B, 6A, and 6B are diagrams illustrating relationships between the positions on the touch panel 17 detected by the control section 11 and the positions of an image representing a trace displayed on the display surface 141 when the positions are detected by using the two sampling rates different from each other. FIGS. 5A and 5B are diagrams showing exemplary cases where the positions t1 successively formed in a curve shape are designated. FIGS. 6A and 6B are diagrams showing exemplary cases where the positions t2 successively formed in a linear shape are designated. FIGS. 5A and 6A show the case of a low sampling rate, and FIGS. 5B and 6B show the case of a high sampling rate. Specifically, the sampling rate shown in FIGS. 5B and 6B is two times that shown in. FIGS. 5A and 6A. In FIGS. 5A, 5B, 6A, and 6B, the dashed lines indicate positions ti and t2 actually designated by the operation of the stylus pen 2 of the user. The segments of the solid line linking the respective points indicate the positions of the image (hereinafter, referred to as a “trace image”) representing a trace displayed on the display surface 141. Furthermore, in the following description, each point referenced by the sign “Pt” represents a position detected by the control section 11, and positions are successively designated by the stylus pen 2 in a direction in which the value added to the end of the sign increases.

First, as shown in FIG. 5A, focusing on change of the direction of the positions t1, it can be observed that the direction of the trace significantly changes at points Pt32, Pt34, Pt36, and Pt38. In addition, in the positions following the respective points, positional difference between the positions t1 and the trace image becomes large. As described above, when the magnitude of change of the direction of the trace is large, difference of positions of the image displayed on the display surface 141 may increase.

On the other hand, as shown in FIG. 5B, when the position is detected at the sampling rate which is two times that shown in FIG. 5A, the point Pt42 is detected between the points Pt32 and Pt33 shown in FIG. 5A, the point Pt44 is detected between the point Pt34 and Pt35, the point Pt46 is detected between the point Pt36 and Pt37, and the point Pt48 is detected between the point Pt38 and Pt39. Thereby, it can be observed that, even at the positions at which the positions t1 and the trace image were deviated from each other in the example shown in FIG. 5A, both of those satisfactorily coincide with each other. As described above, in order accurately to display the trace image based on the positions designated on the display surface 141, it is more preferable to employ a higher sampling rate. However, when the sampling rate is set to be high, the control section 11 more frequently detects the positions by using the touch panel 17. As a result, power consumption of the display apparatus 10 increases.

Subsequently, as shown in FIGS. 6A and 6B, when the designated positions t2 are formed in a linear shape, the trace image is accurately displayed even at any of the sampling rates. As described above, when the designated positions are formed in a linear shape or a curve shape (a substantially linear shape) having a small curvature, the trace image is accurately displayed regardless of a magnitude of the sampling rate. In other words, when the positions successively formed in the linear shape or the substantially linear shape are designated, although the sampling rate is low at the time of position detection performed by the control section 11, this has no negative effect on the display of the trace image. The reason is that, as described above, the control section 11 displays the trace image by sequentially linking the positions, which are detected by the touch panel 17, to each other.

In consideration of the above-mentioned situation, in the case of change of the direction of the trace, the control section 11 increases the sampling rate when the magnitude of the change increases, and decreases the sampling rate when the magnitude of change of the direction of the trace decreases. Here, if it is determined that the increase or the decrease in the magnitude of the change exists, instantly the control section 11 changes the sampling rate. Furthermore, the correspondence relationship between the magnitude of change of the trace direction and the sampling rate has previously been stored in the storage section 16, and the control section 11 changes the sampling rate in accordance with the correspondence relationship.

### A-4. Change of Rewriting Period

The control section 11 of the display apparatus 10 changes the sampling rate as described in the section of “A-3. Change of Sampling Rate”, and in accordance with the change, specifies a period (hereinafter, referred to as a “rewriting period”) during which the rewriting process is performed. Specifically, when the sampling rate is changed to be high (so as to shorten the cycle of the position detection), the control section 11 shortens the rewriting period. In addition, when the sampling rate is changed to be low (so as to elongate the cycle of the position detection), the control section 11 elongates the rewriting period. That is, the control section 11 is an example of a rewriting period changing section. Subsequently, the relationship between the sampling rate and the rewriting period in the display apparatus 10 will be described.

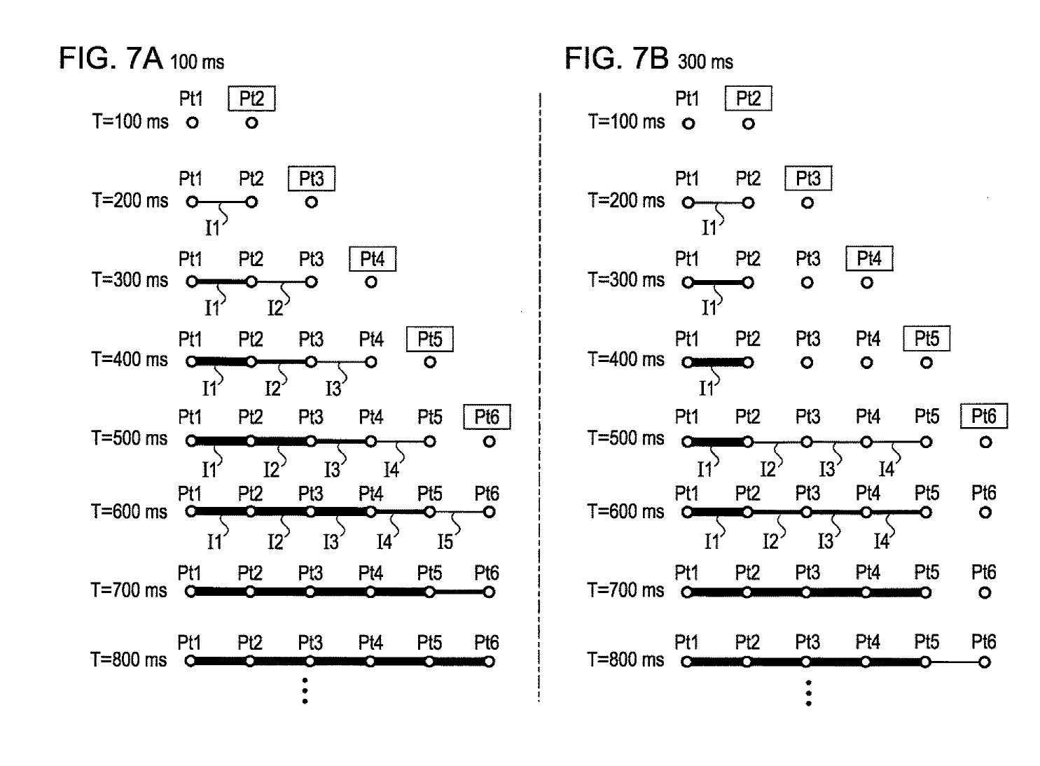

FIGS. 7A and 7B are diagrams illustrating time-series transitions of the trace images displayed when the sampling rate is set to 100 (times/second). FIG. 7A shows an exemplary case where the rewriting period is set to 100 ms. FIG. 7B shows an exemplary case where the rewriting period is set to 300 ms. Here, when the rewriting process is performed for 300 ms, the rewriting process is terminated. When the sampling rate is 100 (times/second), the cycle of the position detection performed by the control section 11 is 100 ms, and thus coincides with the rewriting period of FIG. 7A. Further, in FIGS. 7A and 7B, the point Pt1 is designated at the time T of 0 ms, the positions are successively designated as the points Pt1, Pt2, . . . in a direction in which the value added to the end of the sign increases. Further, in FIG. 7, the pen tip of the stylus pen 2 is located at a position at which the sign “Pt” is surrounded by the rectangular block. Further, the segment of the solid line linking the respective points to each other represents a trace image, and the thicker line means that the color of the trace image is closer to black. Furthermore, in the following description, as a “density” is thicker, the electrophoresis element displays a color that is closer to black and has low brightness.

First, as shown in FIG. 7A, the case where the “rewriting period” is short (100 ms) will be described. When the control section 11 detects the point Pt1 at the time T of 0 ms and detects the point Pt2 at the time T of 100 ms, the rewriting process for displaying a trace image T1 linking the points Pt1 and Pt2 is started. Subsequently, when the time T reaches 200 ms, the control section 11 detects the point Pt3. At this time, since 100 ms elapses from the start of the rewriting process of the trace image the trace image I1 having a low density is displayed. Further, at this time, the control section 11 starts the rewriting process for displaying the trace image I2 linking the points Pt2 and Pt3. Next, at the time T of 300 ms, the control section 11 detects the point Pt4. At this time, since 200 ms elapses from the rewriting process of the trace image I1, the trace image I1 having a medium density is displayed, and since 100 ms elapses from the start of the rewriting process of the trace image I2, the trace image I2 having a low density is displayed. Further, at this time, the control section 11 starts the rewriting process for displaying the trace image I3 linking the points Pt3 and Pt4.

Then, at the time T of 400 ms, the control section 11 detects the point Pt5. At this time, since 300 ms elapses from the start of the rewriting process of the trace image I1, the trace image I1 having a high density is displayed as a final color. Further, since 200 ms elapses from the rewriting process of the trace image I2, the trace image I2 having a medium density is displayed, and since 100 ms elapses from the start of the rewriting process of the trace image I3, the trace image I3 having a low density is displayed. Further, at this time, the control section 11 starts the rewriting process for displaying the trace image I4 linking the points Pt4 and Pt5.

After this time, the control section 11 performs the position detection and the rewriting process in the order described above. As described above, when the control section 11 detects a position, instantly, the control section 11 performs the rewriting process for displaying the trace image linking the position and a position detected just previous thereto. In such a manner, a position is designated by the pen tip of the stylus pen 2, and then the trace image is promptly displayed. Specifically, here, the trace image having a low density is displayed after the elapse of 100 ms from the designation of the position. As described above, if only the trace image having a density lower than that of the final color is displayed, the period of the rewriting process may be short. Therefore, by using this, the display apparatus 10 is configured to display the trace image that the movement of the pen tip is satisfactorily traced.

Next, as shown in FIG. 7B, the case where the “rewriting period” is long (300 ms) will be described. When the control section 11 detects the point Pt2 at the time T of 100 ms, at this time, the rewriting process for displaying a trace image I1 linking the points Pt1 and Pt2 is started. Subsequently, when the time T reaches 200 ms, the control section 11 detects the point Pt3. At this time, since 100 ms elapses from the start of the rewriting process of the trace image I1, the trace image I1 having a low density is displayed. However, since the process is in the middle of the rewriting period, the control section 11 does not start the rewriting process for displaying another trace image. Next, at the time T of 300 ms, the control section 11 detects the point Pt4. At this time, since 200 ms elapses from the start of the rewriting process of the trace image I1, the trace image I1 having a medium density is displayed. However, since the process is also herein in the middle of the rewriting period, the control section 11 does not start the rewriting process for displaying another trace image.

Then, at the time T of 400 ms, the control section 11 detects the position of the point Pt5. At this time, since 300 ms elapses from the start of the rewriting process of the trace image I1, the trace image I1 having a high density is displayed as a final color. Then, the control section 11 starts, at the time T of 400 ms, the rewriting process for displaying the trace images I2, I3, and I4 sequentially linking the detected points Pt2, Pt3, Pt4, and Pt5. As described above, the control section 11 starts the rewriting process for displaying the trace images I2 and I3 at a time later than that of the case shown in FIG. 7A.

After this time, the control section 11 performs the position detection and the rewriting process in the order described above. As described above, when the “rewriting period” is long, although the control section 11 detects a position, the control section 11 is unable to start the rewriting process for displaying another trace image until the rewriting process which is being executed is completed. Specifically, in the example of FIG. 7B, until 300 ms elapses after the control section 11 detects the point Pt3 at the time T of 200 ms, the trace image I3 is not displayed. Accordingly, when the rewriting period is long, the display apparatus 10 is unable to display the trace image that the movement of the pen tip of the stylus pen 2 is satisfactorily traced.

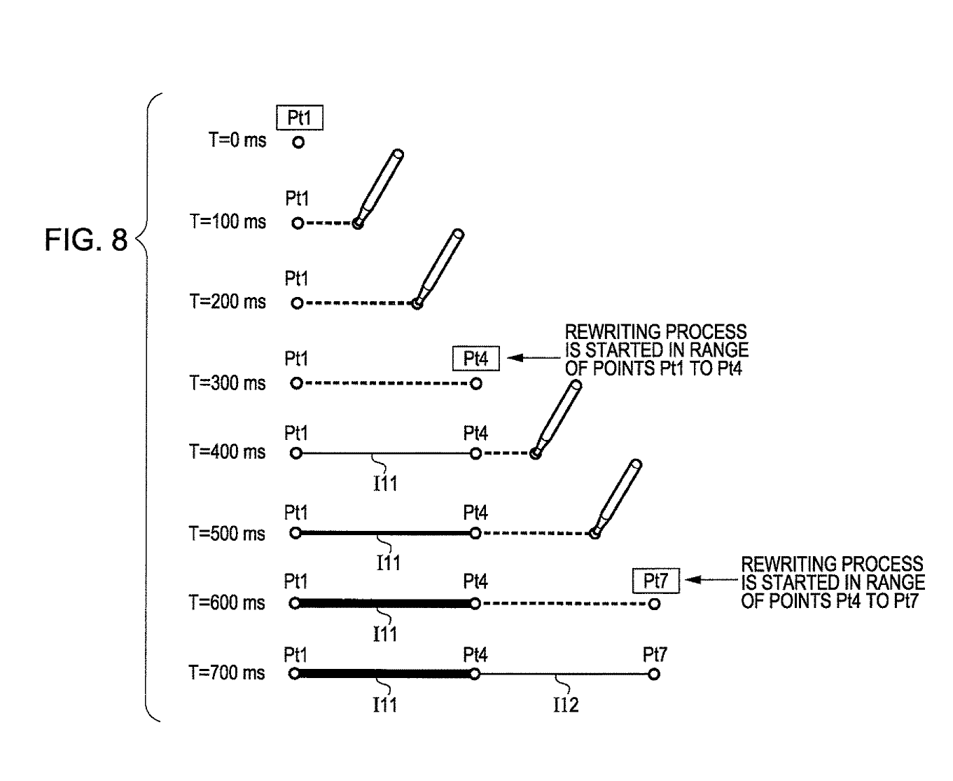

FIG. 8 is a diagram illustrating a time-series transition of the trace image displayed on the display surface 141 when the sampling rate is set to 300 (times/second). Furthermore, when the sampling rate is 300 (times/second), the cycle of the position detection performed by the control section 11 and the touch panel is about 0.003 ms. In FIG. 8, the point Pt1 is designated at the time T of 0 ms, the positions are successively designated as the points Pt1, Pt2, . . . in a direction in which the value added to the end of the sign “Pt” increases. Further, in FIG. 8, the pen tip of the stylus pen 2 is located at a position at which the sign “Pt” is surrounded by the rectangular block. Further, in the drawing, the dashed line indicates a position designated by the stylus pen 2.

The control section 11 detects the point Pt1 at the time T of 0 ms. Next, the control section 11 tries to start the rewriting process at the time T of 100 ms. However, at this point of time, since a position subsequent to the point Pt1 is not yet detected, the control section 11 does not start the rewriting process for displaying the trace image. At the time T of 200 ms, since the subsequent position is also not detected, the control section 11 does not start the rewriting process. Then, at the time T of 300 ms, the control section 11 detects the point Pt4. Further, at this time, the control section 11 starts the rewriting process for displaying the trace image I11 linking the points Pt1 and Pt4.

At the time T of 400 ms, the trace image I11 having a low density is displayed, but the control section 11 does not detect a position subsequent to the point Pt4 yet, and thus in this case also does not start the rewriting process for displaying another trace image. At the time T of 500 ms, the trace image I11 having a medium density is displayed, but the subsequent position is also not detected at this time, and thus the control section 11 does not start the rewriting process for displaying another trace image. Then, at the time T of 600 ms, the control section 11 detects the point Pt7. Here, the control section 11 starts the rewriting process for displaying the trace image I12 linking the points Pt4 and Pt7. At this time, since 300 ms elapses from the start of the rewriting process of the trace image I11, the final trace image I11 having a high density is displayed. As described above, although the control section 11 performs the rewriting process in a period shorter than the position detection cycle, the control section 11 has not yet detected the subsequent position enabling it to start the rewriting process, and thus is unable to start the rewriting process for newly displaying the trace image.

Consequently, in the exemplary case shown in FIG. 8, the control section 11 has only to start the rewriting process for displaying the trace image I11 by detecting the position of the point Pt4 at the time T of 300 ms, and start the rewriting process for displaying the trace image I12 by detecting the position of the point Pt7 at the time T of 600 ms. With such a configuration, the tracing ability for the position designation in the displaying of the trace image is secured. That is, in any cases where the period of the rewriting process is set to 100 ms and is set to 300 ms, the display apparatus 10 displays the trace image at the same time. Accordingly, when the sampling rate is low, the control section 11 elongates the rewriting period, and thereby it is possible to suppress power consumption of the display apparatus 10. The reason is that, in view of the suppression of power consumption, it is more preferable to perform the rewriting process a small number of times in a long rewriting period than to perform the rewriting process a large number of times in a short rewriting period.

In the first embodiment mentioned above, the control section 11 of the display apparatus 10 performs the position detection by changing the sampling rate in accordance with the magnitude of the change of the trace direction, and changes the rewriting period in accordance with the change. In such a manner, the display apparatus 10 is able accurately to display the trace image while suppressing power consumption required for the displaying. Further, when the sampling rate increases or decreases, the control section 11 changes the length of the rewriting period in accordance therewith. In such a manner, it is possible to suppress the power consumption of the display apparatus 10 while securing the tracing ability for the position designation in the displaying of the trace image.

### B. Second Embodiment

Next, a second embodiment of the invention will be described. The embodiment is characterized in that the sampling rate and the rewriting period are changed in the designation method of successively designating positions on the display surface 141 on the basis of a displacement per unit of time (hereinafter, referred to as a “designation rate”). Furthermore, in the case where there are some elements in common with the first embodiment, those elements will be referenced by the same reference numerals and signs, and description thereof will be omitted.

In the second embodiment, the control section 11 calculates a designation rate whenever a position is detected. Specifically, the control section 11 calculates a value as a designation rate by dividing a distance between two positions successively detected on the touch panel 17 by a cycle at the time of the position detection. In such a manner, the control section 11 specifies a displacement of the pen tip per unit of time. Then, the control section 11 increases the sampling rate when the designation rate increases, and decreases the sampling rate when the designation rate decreases. Furthermore, a correspondence relationship between a magnitude of change of the designation rate and the sampling rate is previously stored in the storage section 16. On the basis of the correspondence relationship, the control section 11 changes the sampling rate, and thus changes the rewriting period in the same manner as the first embodiment.

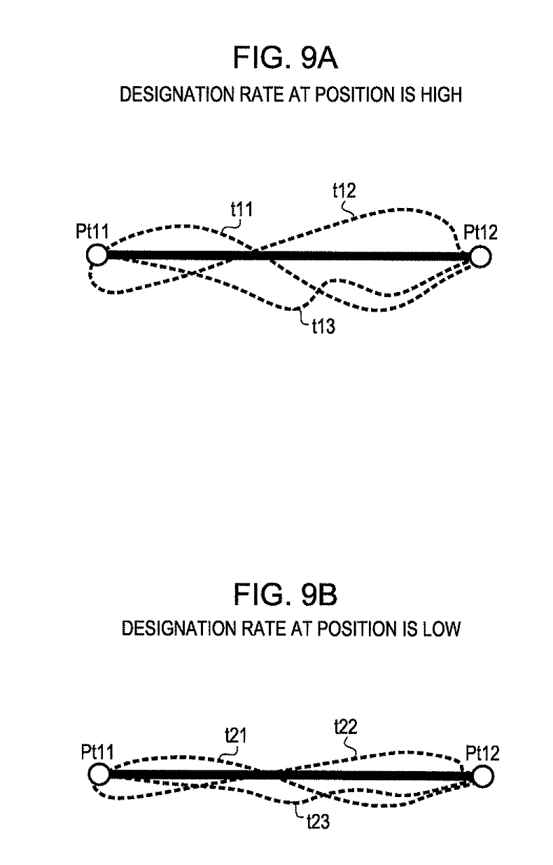

FIGS. 9A and 9B are diagrams illustrating a relationship between positions on the touch panel 17 and positions of a trace image which is displayed on the display surface 141.

When the control section 11 performs the position detection at a certain constant sampling rate, the distance between the detected positions becomes larger as the designation rate becomes higher. Since the display apparatus 10 displays the image on the display surface 141 by sequentially linking the detected positions, an accuracy of the trace image relative to the designated positions tends to become lower as the designation rate becomes higher. For example, as shown in FIG. 9A, even when the trace image I11 linking the points Pt11 and Pt12 is displayed, it can be considered that the positions actually designated by a user have various ways such as t11 to t13. Hence, in accordance with the designation method, the accuracy of the trace image is noticeably lost. On the other hand, as shown in FIG. 9B, a shape of the positions successively designated at a small designation rate is more restricted than those at a large designation rate shown in FIG. 9A. Thus, as shown in the positions t21 to t23, the shape thereof may approach to the shape linking the points Pt11 and Pt12 as a segment. Accordingly, the control section 11 is configured to display the trace image accurately by increasing the sampling rate at the time of increasing the designation rate, and to suppress power consumption by decreasing the sampling rate at the time of decreasing the designation rate.

Even in this case, the control section 11 changes the rewriting period in accordance with the change of the sampling rate, and thus it is possible to suppress power consumption while securing the tracing ability for the movement of the pen tip for the same reason as for the description of FIGS. 7A, 7B, and 8.

### C. Modified Examples

Furthermore, the embodiment may be modified as follows. Specifically, for example, the following modifications are exemplified. In such modifications, the respective elements may be appropriately combined.

### C-1. Modified Example 1

The designation method of successively designating positions on the display surface 141 is based on the direction of the trace in the above-mentioned first embodiment, and is based on the designation rate in the second embodiment. Regarding this, when a position is designated by the stylus pen 2, the control section 11 may change the rewriting period in accordance with the sampling rate. In this case, as described in FIGS. 7A, 7B, and 8, the effects equivalent to those of the embodiments are obtained. Accordingly, when a position is designated by the stylus pen 2, the control section 11 may change the sampling rate with each momentum.

Further, the display apparatus 10 may employ both designation methods of the direction of the trace and the designation rate. In this case, the control section 11 may specify the sampling rate on the basis of the respective designation method, and may employ a higher one thereof or a lower one thereof. Further, the control section 11 may specify the rewriting period based on the sampling rate after the correction by calculating the sampling rate in any one designation method and correcting the sampling rate in the other one designation method. For example, the control section 11 corrects the sampling rate calculated on the basis of the magnitude of change of the trace direction to be high when the designation rate is high.

### C-2. Modified Example 2

In the above-mentioned first and second embodiments, the cycle that the control section 11 detects positions by using the touch panel 17 coincides with the rewriting period. Thereby, the control section 11 starts the rewriting process right after the position detection, and thus it is possible to display promptly the trace image. Regarding this, the control section 11 may set a rewriting period longer than the sampling rate. In this case, the tracing ability for the position designation in the displaying of the trace image is slightly lowered, but it is possible to display the trace image at a higher density. As a result, there is an advantage that a user can easily be in visual contact therewith.

### C-3. Modified Example 3

In the above-mentioned first embodiment, the control section 11 allows a user to designate successive positions, and calculates the magnitude of change of the trace direction whenever detecting the position. However, the control section may calculate the magnitude of change of the direction of the trace for each cycle longer than the position detection cycle for displaying the trace image on the display surface 141. Further, in the second embodiment, the control section 11 may calculate the designation rate for each cycle longer than the position detection cycle for displaying the trace image on the display surface 141.

### C-4. Modified Example 4

In the above-mentioned first embodiment, the control section 11 may change the sampling rate on the basis of a frequency exceeding a threshold value of the magnitude of change of the trace direction. For example, the positions formed in a curve shape, which has a large curvature by the number of times per unit of time equal to or more than the threshold value, may be designated. In this case, it seems very possible that the positions formed in a curve shape having a large curvature are also designated thereafter. Accordingly, if the control section 11 determines that the frequency of an increase in the magnitude of change of the trace direction exceeds the threshold value, the control section 11 may perform the position detection with a high sampling rate maintained until the designation of the successive positions is terminated. In the same manner, if the frequency of a decrease in the magnitude of change of the trace direction exceeds the threshold value, the control section 11 may lower the sampling rate until the drawing is terminated. In the second embodiment, if the control section 11 determines that the frequency of an increase in designation rate exceeds the threshold value, the control section 11 may perform the position detection with a high sampling rate maintained until the designation of the successive positions is terminated. In the same manner, if the frequency of a decrease in the designation rate exceeds the threshold value, the control section 11 may lower the sampling rate until the drawing is terminated.

### C-5. Modified Example 5

In the above-mentioned first embodiment, the display apparatus 10 increases the sampling rate when the magnitude of change of the specific trace direction increases, and decreases the sampling rate when the magnitude of change of the trace direction decreases. In contrast, the display apparatus 10 may perform any one of these. For example, the control section 11 increases the sampling rate from an initial setting value when the magnitude of change of the direction of the specific trace increases, and returns the increased sampling rate to the initial setting value when a predetermined time elapses. In the same manner, the control section 11 decreases the sampling rate from the initial setting value when the magnitude of change of the direction of the specific trace decreases, and returns the decreased sampling rate to the initial setting value when a predetermined time elapses. Further, in the second embodiment, the control section 11 increases the sampling rate from an initial setting value when the designation rate increases, and returns the increased sampling rate to the initial setting value when a predetermined time elapses. In addition, the control section 11 decreases the sampling rate from the initial setting value when the designation rate decreases, and returns the decreased sampling rate to the initial setting value when a predetermined time elapses.

### C-6. Modified Example 6

In the above-mentioned first and second embodiments, the storable display body 14 includes a display surface 141 having the electrophoresis elements. However, the other display elements may be used if only those have characteristics that colors are transmitted in accordance with the rewriting period and subsequently a final color is displayed. Further, since the “rewriting process” is a process for rewriting a color of each display element, contents thereof are changed in accordance with the display element. Further, it is not necessary that the color of the display element changes in proportion to the rewriting period, and the color of the display element has only to change in accordance with the rewriting period at least in a period of a predetermined range. For example, the color may be scarcely changed in the rewriting period of 0 to 100 ms, the color may be changed in accordance with the rewriting period in the rewriting period of 100 to 200 ms, and the color may be scarcely changed in the rewriting period of 200 to 300 ms. Even in this case, at least in the rewriting period of 100 to 200 ms, the color is changed in accordance with the rewriting period. Therefore, the display element having the above configuration corresponds to a display element of which a color is rewritten in accordance with the period of executing the rewriting process.

Further, it may be possible to use a display element capable of freely performing density control. In short, any display element may be used if only a color of the display element is to be rewritten in the period of executing the rewriting process. Further, the display apparatus 10 may display a single color image, and may display a multi-color image.

### C-7. Modified Example 7

In the above-mentioned first and second embodiments, the display apparatus 10 is a thin and portable display apparatus which is called an electronic paper. However, any display apparatus may be used if only it is able to perform the information process as described in the embodiments, and a display apparatus such as a PDA or mobile phone may be used.

### C-8. Modified Example 8

In the above-mentioned first and second embodiments, the stylus pen 2 is used when a user designates positions, but it is apparent that a finger of the user may be used for the designation. Further, the stylus pen may have the function of detecting the successively designated positions. In this case, coordinates of the positions are notified from the stylus pen to the display apparatus main body by using a wireless signal and the like, and the main body may change the sampling rate by calculating a degree of the change in the designation method in accordance therewith.

Further, instead of the touch panel 17 disposed on the display surface 141, a pen tablet may be used. That is, when a user designates the trace on a planar tablet by using a pen type input device or a mouse, the apparatus displays the trace image on the display surface by reading the position coordinates representing the positions and moving a pointer on the display.

### C-9. Modified Example 9

In the above-mentioned first and second embodiments, the entire control is performed by the control section 11, but a part of the control may be performed in cooperation with another hardware, and may be performed by one or a plurality of hardware other than that. Further, when the control section 11 executes a program to perform various controls, the program may be embodied by combination of a plurality of programs. In addition, the program can be provided in a state where it is recorded in a computer-readable recording medium such as a magnetic recording medium (a magnetic tape, a magnetic disk, or the like), an optical recording medium (an optical disk such as a CD or a DVD, or the like), a magnetic optical recording medium, or a semiconductor memory. Further, the program may be downloaded via a communication network such as an Internet.

What is claimed is:

1. A display apparatus comprising:
a display surface that includes a plurality of display elements of which colors are rewritten in accordance with a period of executing a rewriting process;
a detection section that detects positions of the plurality of display elements subjected to the rewriting for each predetermined cycle;
a rewriting section that rewrites colors of the corresponding display elements by performing the rewriting process on the display elements corresponding to a trace sequentially linking the positions detected by the detection section;
a cycle changing section that, when the positions are designated, changes the cycle in which the detection section detects the corresponding positions; and
a rewriting period changing section that, when the cycle changing section changes the cycle to be shortened, shortens a period of the rewriting process which is performed on the display elements by the rewriting section.

2. A display apparatus comprising:
a display surface that includes a plurality of display elements of which colors are rewritten in accordance with a period of executing a rewriting process;
a detection section that detects positions of the plurality of display elements subjected to the rewriting for each predetermined cycle;
a rewriting section that rewrites colors of the corresponding display elements by performing the rewriting process on the display elements corresponding to a trace sequentially linking the positions detected by the detection section;
a cycle changing section that, when the positions are designated, changes the cycle in which the detection section detects the corresponding positions; and
a rewriting period changing section that, when the cycle changing section changes the cycle to be elongated, elongates a period of the rewriting process which is performed on the display elements by the rewriting section.

3. The display apparatus according to claim 1,
wherein the cycle changing section includes a direction specifying section that, when the detection section detects the positions, specifies a direction of the trace at the corresponding positions, and
wherein in a case where the direction of the trace specified by the direction specifying section changes, the cycle changing section shortens the cycle, in which the detection section detects the positions, when a magnitude of the change of the corresponding direction increases, and elongates the cycle, in which the detection section detects the positions, when the magnitude of the change of the direction decreases.

4. The display apparatus according to claim 1,
wherein the cycle changing section includes a displacement specifying section that specifies a displacement of the corresponding positions per unit of time when the positions are successively designated, and
wherein the cycle changing section shortens the cycle, in which the detection section detects the positions, when the displacement specified by the displacement specifying section increases, and elongates the cycle, in which the detection section detects the positions, when the displacement decreases.

5. The display apparatus according to claim 1, wherein the rewriting period changing section changes the period of the rewriting process to coincide with the cycle in which the detection section detects the positions.

6. A program for causing a computer, which controls a display apparatus having a display surface that includes a plurality of display elements of which colors are rewritten in accordance with a period of executing a rewriting process, to function as:
a detection section that detects positions of the plurality of display elements subjected to the rewriting for each predetermined cycle;
a rewriting section that rewrites colors of the corresponding display elements by performing the rewriting process on the display elements corresponding to a trace sequentially linking the positions detected by the detection section;
a cycle changing section that, when the positions are designated, changes the cycle in which the detection section detects the corresponding positions; and
a rewriting period changing section that, when the cycle changing section changes the cycle to be shortened, shortens a period of the rewriting process which is performed on the display elements by the rewriting section.

7. A program for causing a computer, which controls a display apparatus having a display surface that includes a plurality of display elements of which colors are rewritten in accordance with a period of executing a rewriting process, to function as:
a detection section that detects positions of the plurality of display elements subjected to the rewriting for each predetermined cycle;
a rewriting section that rewrites colors of the corresponding display elements by performing the rewriting process on the display elements corresponding to a trace sequentially linking the positions detected by the detection section;
a cycle changing section that, when the positions are designated, changes the cycle in which the detection section detects the corresponding positions; and
a rewriting period changing section that, when the cycle changing section changes the cycle to be elongated, elongates a period of the rewriting process which is performed on the display elements by the rewriting section.
